(19) United States
(12) Patent Application Publication
(10) Pub. No.: US 2010/0062757 A1
(43) Pub. Date: Mar. 11, 2010

(54) SWITCHING ANTENNAS IN A WIRELESS DEVICE

(75) Inventor: Guy REINA, Givataim (IL)

Correspondence Address: MARTIN D. MOYNIHAN d/b/a PRTSI, INC., P.O. BOX 16446, ARLINGTON, VA, 22215, US

(73) Assignee: Alvarion Ltd., Tel-Aviv (IL)

(21) Appl. No.: 12/208,362

(22) Filed: Sep. 11, 2008

(51) Int. Cl. H04Q 7/30

(52) U.S. Cl. 455/424

(57) ABSTRACT

A method for configuring a terminal in a wireless system comprising at least one terminal and at least one base station, comprising:
(a) negotiating between a terminal with a base station to obtain an absence period for the terminal;
(b) setting the terminal in an absence mode with respect to the base station; and
(c) at least partially configuring the terminal independently of the base station, during the absence mode. Optionally, the configuration comprises switching antenna.

### FIELD OF THE INVENTION

This invention relates to wireless communications Some embodiments relate to methods for utilizing a particular mode of a wireless device.

### BACKGROUND OF THE INVENTION

Wireless communications and networking are an extension of the wired communications and networking systems. While wired devices typically have access to mains power supply, common portable wireless devices are battery operated.

Since battery power is limited, portable devices such as laptop computers with wireless adapters, or mobile devices such as cellular phones or other handsets, are typically designed to save battery life. For example, a portable device may weigh less than 10 Kg, 5 Kg, 3 Kg, 1 Kg, 0.5 Kg, 0.3 Kg or 0.15 Kg. In another example, a portable device may fit into a user's bag or pocket.

Some wireless communications designs, such as OFDM (Orthogonal Frequency Division Multiplexing) or protocols such as 802.16 or cellular networks, enable a device to enter an energy-saving mode (e.g. sleep mode). During an energy-saving mode the device does not participate in regular communications with other devices but, rather, performs some minimal operations such as keeping time for the energy saving mode until the mode period expires.

The sleep mode of a wireless system was used in US application 2006/0030305 that describes a method for a ranging process wherein the base station provides the mobile device with initial notification of a periodic ranging time in a sleep mode.

Techniques for antennas switching in wireless systems were described, for example, in wwwdotairspandotcom/pdfs/Whitepaper_Multiple_Antenna_Systemsdotpdf or US application publication 2006/030278. The disclosures of the cited references are incorporated herein by reference.

### SUMMARY OF THE INVENTION

A broad aspect of some exemplary embodiments of the invention relates to configuration of a wireless system comprising a base station and one or more devices (hereinafter ‘terminals’) such as end user devices, such as Customer-premises equipments (“CPE”s), mobile stations and/or handsets, that communicate with the base station, where the base station relays or manages or coordinates communications between the terminals and other devices of the system. Typically such systems are referred to as Point-to-Multi-Point systems (MtMP). In an exemplary embodiment of the invention, the configuration uses a time period of an absence mode during which the terminal is allowed to not be online with a base-station and/or has reduced functionality.

In an exemplary embodiment of the invention, the wireless system operates according to a design comprising a set of procedures that define or direct, at least partly, the operation of the system components, the interaction between the components and timing of the interactions (hereinafter ‘system protocol’).

In an exemplary embodiment of the invention, a terminal may negotiate with a base station to enter and/or set a mode during which the terminal does not participate in regular communications (e.g., user data transmission and reception) with the base station (such as an idle mode, sleep mode or handoff mode, hereinafter ‘absence mode’). Once the base station acknowledges that a terminal is in an absence mode, the base station stores incoming messages for the terminal and subsequently transmits them to the terminal after the terminal exits the absence mode.

It should be noted that the absence mode period is typically intended to save energy of the terminals or to allow a terminal to perform operations directed by the system protocol, such as switching to another base station. On the other hand, the absence mode typically burdens the base station, as it requires additional operations and/or storage space.

In some cases or systems or embodiments of the invention, an absence mode comprises one or more of a sleep mode (e.g. a period of minimal or low activity and optionally saving power) or other idle mode (e.g. receiving but not transmitting), or other special modes that may reduce energy consumption of a terminal or activity in the wireless system. In some cases or systems or embodiments of the invention an absence mode comprises, a period of a handoff process (e.g. scanning for a new base station and optionally selecting a new base station). In some cases, a plurality of absences, optionally of different types, are used for a process, such as configuration. Optionally, the process includes a planning section that takes into account the probability of being provided with various absence modes.

Typically, without limiting, the terminal and other devices and components of the wireless system comprise one or more processors or computing apparatus and are, at least partly, controlled and/or operated by hardware units and/or circuitry and/or software modules.

In the specifications and claims, unless otherwise specified, the term ‘mode’ denotes the meaning of the art pertaining to electronics or software components, such as a particular functioning state, condition or arrangement.

In the specifications and claims, unless otherwise specified, the terms ‘terminal’, ‘system protocol’ and ‘absence mode’ denote the characterization preceding their introduction above.

In the specifications and claims that follow, unless otherwise specified, a point-to-multi-point wireless system is used or assumed as an exemplary system, while the principles and/or methods apply to any wireless system that provides an absence mode of a device with respect to another device, optionally with some variations.

An aspect of some exemplary embodiments of the invention relates to configuring a terminal in an absence mode.

In some embodiments of the invention, the configuration comprises switching antennas between a plurality of antennas, scanning for and optionally switching to a different base station, adjusting transmission and/or reception power, and/or beam forming. Optionally or alternatively, the configuration includes a configuration of the wireless link, such as via a wireless configuration process. Optionally or alternatively, a configuration process comprises other operations, some of which may not be directed specifically to configuration of the terminal such as message forwarding.

An aspect of some exemplary embodiments of the invention relates to obtaining an absence mode period for a terminal according to an intended configuration.

In some embodiments of the invention, the absence mode period is divided into a plurality of periods wherein the configuration is performed in part during each of the plurality of periods. Optionally, more important configuration activities are carried out first.

There is provided in accordance with an exemplary embodiment of the invention, a method for configuring a terminal in a wireless system comprising at least one terminal and at least one base station, comprising:

(a) negotiating between a terminal with a base station to obtain an absence period for the terminal;

(b) setting the terminal in an absence mode with respect to the base station; and

(c) at least partially configuring the terminal independently of the base station, during the absence mode.

In an exemplary embodiment of the invention, the configuration is carried out without notifying the base station.

Optionally or alternatively, the configuration is carried out without coordinating the configuration with the base station.

Optionally or alternatively, the configuration is carried out independently of the system protocol.

Optionally or alternatively, the configuration does not require a modification in another device communicating with the terminal.

In an exemplary embodiment of the invention, the configuration comprises switching antennas in a terminal comprising a plurality of antennas. Optionally, switching antennas comprises:

(a) receiving signals in a plurality of antennas; and

(b) selecting at least one antenna as an active antenna. Optionally selecting is according to at least one characteristic of the signals. Optionally, a characteristic of a signal comprises at least one of an indication of the intensity of a signal, or a quality of a signal, or a combination thereof. Optionally, an indication of the intensity of a signal comprises at least one of a received-signal-strength-indication (RSSI), or carrier-to-interference-ratio (CIR), or signal-to-noise ratio (SNR), or a combination thereof. Optionally or alternatively, an indication of the quality of a signal comprises at least one of an error rate, or percentage of errors, or a combination thereof.

In an exemplary embodiment of the invention, the antennas switching consumes a negligible amount of energy for transmission relative to energy consumption for transmission in normal operation of the terminal.

In an exemplary embodiment of the invention, the antennas switching consumes less than 50% of the energy level used for normal operation of the terminal.

In an exemplary embodiment of the invention, the configuration comprises adjusting the power of the terminal. Optionally, adjusting the power comprises setting the power to attain a sufficient quality of communications while avoiding expenditure of superfluous power.

In an exemplary embodiment of the invention, the configuration comprises forming a beam of one or more antenna at the terminal. Optionally, a beam is formed by a plurality of antennas in a terminal comprising a plurality of antennas.

In an exemplary embodiment of the invention, the configuration comprises a handoff operation.

In an exemplary embodiment of the invention, the wireless system conforms to a standard wireless protocol. Optionally, the protocol comprises an OFDM (Orthogonal Frequency Division Multiplexing) protocol.

In an exemplary embodiment of the invention, the protocol comprises a wireless protocol. Optionally, the protocol includes a provision for a low energy state of the terminal. Optionally, the protocol is one of a WiMax protocol, or a cellular protocol, or a WiFi protocol, or a BlueTooth protocol, or a ZigBee protocol.

In an exemplary embodiment of the invention, the terminal comprises a mobile device.

In an exemplary embodiment of the invention, the absence mode comprises a less than fully active mode, including one or more of a low energy mode, a sleep mode, idle mode, handoff mode, non-transmission mode, non-listening mode, scanning mode or non-linked mode.

There is provided in accordance with an exemplary embodiment of the invention, a method for deceptively obtaining from a base station an absence mode period for a terminal in a wireless system comprising at least one terminal and at least one base station, comprising:

(a) negotiating with the base station to obtain an absence mode period for the terminal according to an intended configuration process by the terminal; and

(b) obtaining, from the base station, and using an absence mode period for a purpose unrelated to the absence mode as negotiated with the base station.

In an exemplary embodiment of the invention, negotiating comprises requesting by the terminal an absence mode period from the base station. Optionally or alternatively, the purpose is at least a part of the intended configuration. Optionally or alternatively, the absence mode period is obtained in plurality of consecutive absence mode periods. Optionally, a terminal configuration is carried out partially in the consecutive absence mode periods.

In an exemplary embodiment of the invention, an intended configuration is responsive to an unfavorable situation of the terminal. Optionally, an unfavorable situation comprises at least one of a deteriorating reception power or deteriorating reception quality.

In an exemplary embodiment of the invention, an intended configuration is responsive to at least one of a scheduled event, or low power situation, or power loss event, or a manual event. Optionally, a manual event comprises an operation by a person.

In an exemplary embodiment of the invention, the purpose comprises switching antennas in a terminal comprising a plurality of antennas.

In an exemplary embodiment of the invention, the purpose comprises forming a beam.

In an exemplary embodiment of the invention, the purpose comprises a handoff operation.

In an exemplary embodiment of the invention, the absence mode comprises a less than fully active mode, including one or more of a low energy mode, a sleep mode, idle mode, handoff mode, non-transmission mode, non-listening mode, scanning mode or non-linked mode.

There is provided in accordance with an exemplary embodiment of the invention, wireless device configured for configuration, comprising:

(a) circuitry which performs at least one of negotiating, requesting, accepting and applying for an absence mode; and

(b) at least one module which configures the device while in an absence mode. Optionally, the at least one module comprises at least one of a hardware or software module. Optionally or alternatively, configuration comprises antenna switching in a device comprising a plurality of antennas. Optionally or alternatively, the configuration comprises forming a beam. Optionally or alternatively, the absence mode comprises a less than fully active mode, including one or more of a low energy mode, a sleep mode, idle mode, handoff mode, non-transmission mode, non-listening mode, scanning mode or non-linked mode.

In an exemplary embodiment of the invention, the device is portable.

There is provided in accordance with an exemplary embodiment of the invention, a WiMax system comprising a WiMax base station and a plurality of devices as described herein, which serve as terminals, wherein said base station is programmed to accept absence mode requests independently of their usage by said terminals.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the accompanying drawings, identical and/or equivalent and/or similar structures, elements, or parts that appear in more than one drawing are generally labeled with the same numeral in the drawings in which they appear. Dimensions of components and features shown in the figures are chosen for convenience or clarity of presentation and are not necessarily shown to scale.

FIG. 1 schematically illustrates a wireless terminal comprising a plurality of antennas, in accordance with exemplary embodiments of the invention;

FIG. 2 schematically illustrates a wireless system having a base station comprising a transceiver (transmitter/receiver) communicating with a wireless terminal in accordance with exemplary embodiments of the invention;

FIG. 3 is a flowchart schematically outlining an operation sequence for configuring a wireless terminal in an absence mode, in accordance with exemplary embodiments of the invention;

FIG. 4 is a time-line schematically outlining an operation sequence for configuring a wireless terminal in an absence mode, in accordance with exemplary embodiments of the invention;

FIG. 5 schematically illustrates an arrangement for antenna switching in a terminal comprising a plurality of antennas, in accordance with exemplary embodiments of the invention;

FIG. 6 is a flowchart schematically illustrating operations for antenna switching in a wireless terminal comprising a plurality of antennas, in accordance with exemplary embodiments of the invention;

FIG. 7 is a flowchart schematically illustrating operations for a handoff operation in a wireless terminal, in accordance with exemplary embodiments of the invention; and

FIG. 8 is a flowchart schematically outlining a simplified operation sequence for configuring a wireless terminal in an absence mode, in accordance with exemplary embodiments of the invention.

### DETAILED DESCRIPTION OF EMBODIMENTS OF THE INVENTION

An aspect of some exemplary embodiments of the invention relates to configuring a terminal in an absence mode, optionally bypassing a base station configuration control and/or a system protocol.

In some embodiments of the invention, bypassing a base station relates to a configuration process which is not coordinated with the base station and/or without notifying the base station of the configuration.

In some embodiments of the invention, configuring a terminal bypassing of the system protocol comprises configuring which is not a part of, or is not supported by, the system protocol. Optionally, configuring a terminal bypassing the system protocol relates to a configuration which is not a part of, or is not supported by, the system protocol in the absence mode.

In some embodiments of the invention, the configuration comprises selecting, in a terminal comprising a plurality of antennas, one or more antennas from a plurality of antennas to act as an active antenna or antennas for reception and/or transmission.

In some embodiments of the invention, the configuration comprises adjusting the reception power and/or the transmission power.

In some embodiments of the invention, the configuration comprises forming and/or directing a beam towards the base station or other devices of the wireless system.

In some embodiments of the invention, the configuration comprises, at least in part, a handoff process in which the terminal scans for candidate base stations and optionally selects a new base station. It should be noted that in exemplary embodiments of the invention when the absence mode is requested as “handoff” time, handoff is not the only act carried out during the absence mode period.

Optionally, the configuration comprises other operations not necessarily directed to configuration of the terminal such as message forwarding in which the terminal transmits formerly received data to other devices of the network (optionally via a different base station).

An aspect of some exemplary embodiments of the invention relates to deceptively obtaining from a base station an absence mode for a terminal according to an intended configuration process by the terminal.

In some embodiments of the invention the intended configuration is a determined and/or planned configuration. In some embodiments negotiating comprises requesting from the base station, by the terminal, of an absence mode period for the terminal.

In some embodiments of the invention, deceptively obtaining comprises negotiating by the terminal, with the base station, for an absence mode period for a purpose unrelated to the absence mode request as negotiated with the base station. In some embodiments the purpose is at least, in part an intended configuration or other operations intended by the terminal. For example, the negotiated absence mode is a sleep mode (i.e. energy saving mode) while the purpose is antenna switching or other operations which are not supported by the system protocol in a sleep mode.

In some embodiments of the invention a determined configuration comprises a configuration according to a determination by the terminal of a unfavorable situation. For example, a deteriorating reception quality such as in terms of power and/or signal to noise ratio and/or number of errors occurring in reception or missing responses from a base station (such when a message has to be acknowledged).

In some embodiments of the invention a planned configuration comprises a configuration responsive to an event such as low power or power loss, or a manual event such as an operation by a person. For example, a person triggering a configuration such as by pressing a button or moving a lever or clicking on an icon in a GUI (graphical user interface) or invoking a program.

In some embodiments of the invention a planned configuration comprises a scheduled configuration such as according to time, date and/or an elapsed period since a previous configuration.

The non-limiting section headings used herein are intended for convenience only and are not to be considered as necessarily limiting the scope of the invention.

### Exemplary Absence Mode Period

In some embodiments of the invention, the terminal obtains an absence mode period according to the determined configuration operations or activities the terminal is about to perform or has already partially performed. In some embodiments, the absence mode period required or determined for the configuration is requested and/or obtained as a plurality of shorter absence mode periods. Optionally, the configuration is carried out in part in each or some of the periods.

In some cases or embodiments of the invention, an absence mode lasts for a particular period as negotiated by the terminal and the base station. In some cases or embodiments the absence mode period is determined or preset according to the negotiated mode, such a energy saving (e.g. sleep mode) or handoff. In some cases or embodiments the absence mode is extended, for example, by the terminal requesting the base station of an extension of the absence mode period. In some cases or embodiments the absence mode is shortened, for example, due to an event that affects the absence mode according to the system protocol (e.g. transmission to the terminal, ‘wakeup’ or ‘paging’). It should be noted that there are cases when the absence mode period is not shortened due to external events as, in principle, in some embodiments the terminal is not directed by the system protocol to listen to messages.

In an exemplary embodiment of the invention, the terminal can shorten the absence by initiating communication with the base station. Optionally, a variation of the absence protocol is used, in which a terminal can listen to the base station, for example, at preset and/or decided upon times, and/or without any preset times (e.g., the base station repeatedly transmitting) without the base station being able to deny the continuation of the absence mode, if the terminal so desires.

Typically, without limiting, the absence mode period is based on an integral number of communication frames or packets. In the specifications and claims, unless otherwise specified, a frame or packet thereinafter a ‘frame’) denote the usual meaning in the communications art, such as a section of data that is transmitted as a unit in an electronic communications and typically comprises a header subsection and optionally a trailer subsection.

### Exemplary Absence Mode Negotiation

In some cases or embodiments of the invention, a terminal requests the base station to permit the terminal to enter or set an absence mode, and the terminal enters or sets an absence mode responsive to acknowledgment by the base station. In some cases or embodiments of the invention, the base station instructs the terminal to enter or set an absence mode and the terminal enters or sets an absence mode, optionally after acknowledging the instruction.

In some embodiments of the invention, the absence mode comprises an energy saving mode. Optionally or alternatively, contrary to what the base station acknowledges or perceives, the terminal is actually is, at least partially, not in an energy saving mode and/or consumes energy beyond a typical consumption in an energy saving mode. In an exemplary embodiment of the invention, the base station uses less than 70%, 50%, 30%, 20% of an average energy use (e.g., over an hour) of a fuller operating base station. Optionally or alternatively, less than 20%, 10% of the energy levels normally used for transmission (and/or reception) are provided for transmission (and/or reception). Optionally, the base station and/or processing section thereof uses at least 20%, 30%, 40% or more of the average energy levels used by the station or section, respectively, in the 30 minutes just before the absence mode. Such use levels may indicate that the mode of operating is not actually an energy saving mode.

In some embodiments of the invention, the absence mode comprises a handoff mode. Optionally or alternatively, contrary to what the base station acknowledges or perceives, the terminal is actually is, at least partially, not in a handoff mode and/or does not perform operations of or related to a handoff mode.

Optionally, without limiting, in some embodiments of the invention the configuration is performed transparently to a base station; that is, no modification is required in the base station equipment and the base station does not discern the new configuration or a modification of a configuration.

### Exemplary Devices and Antennas

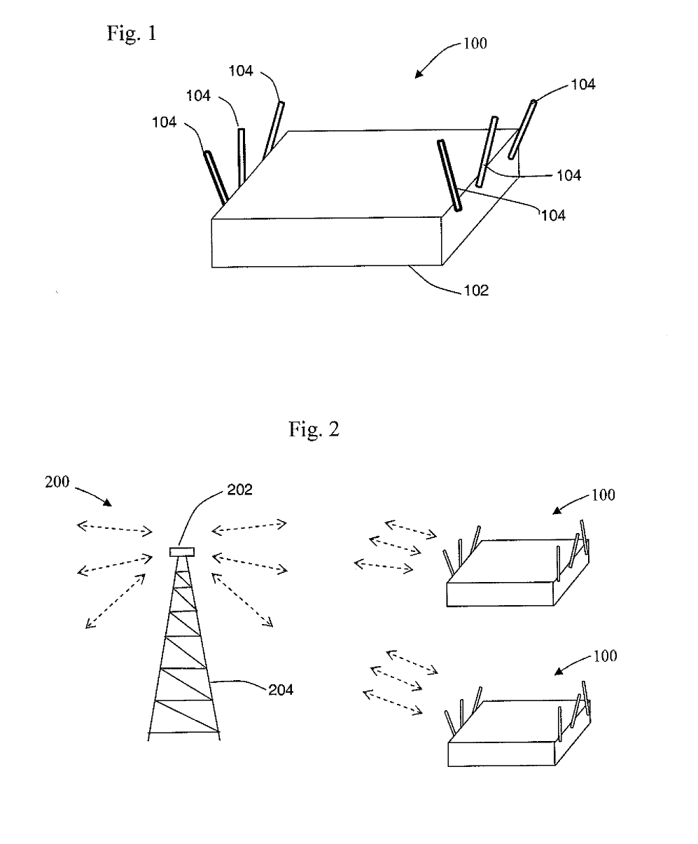

FIG. 1 schematically illustrates a wireless terminal 100 comprising a plurality of antennas 104 optionally mounted on or in a body 102, in accordance with exemplary embodiments of the invention. For example, 1, 2, 3, 4, 6, 8 or more antenna may be provided.

In exemplary embodiments of the invention, terminal 100 may be provided in the form of a wireless adapter such as a computer bus card, a PCMCIA card, a USB appliance, rack mount case (e.g. for 19″ rack), a computer case, a computer plug-in card, a cellular phone, a wireless handset, or other mobile device, or any device that comprises the circuitry for wireless communications.

In exemplary embodiments of the invention, antennas 104, or part thereof may be mechanically mounted on terminal 100. Optionally or alternatively, antennas 104, or part thereof, are not mechanically fixed to terminal 100 but, rather, connect to terminal 100 electrically by wire, or electronically by network, or by a local range wireless link (distinct from the wireless communications of terminal 100).

In exemplary embodiments of the invention, antenna 104 comprises a wire, a rod, a plate, a spherical or parabolic surface, or any other shape adapted to receive and/or transmit wireless signals of terminal 100 communications.

In some cases, the configuration time depends on the number of nodes and/or antenna.

In exemplary embodiments of the invention, antennas 104 have the same or equal structure. Optionally or alternatively, one or more antennas 104 have different structure relative to other antennas 104.

In exemplary embodiments of the invention, antennas 104 have different orientations (e.g. as in FIG. 1), such that one or more antennas may provide better reception and/or transmission in particular directions relative to other directions. Optionally, antenna 104 may be rotated and/or moved to different positions and/or orientations. Optionally, the rotation and/or movement comprise a part of antennas switching. Optionally or alternatively, one or more antennas 104 may have similar orientations, for example, when they are distant from each other such that one antenna has a better reception relative to another with the same or similar orientation; or, for example, when terminal 100 operates in a scattering environment with many reflections such that nearby antennas (possibly separated by a distance in the order of a wavelength) may have different receptions levels.

In exemplary embodiments of the invention, a plurality of antennas 104 may be used simultaneously. Optionally, receptions from a plurality of antennas 100 are combined, optionally with different weights, to yield a better reception. For example, when a reception in one antenna is weak (fading) relative to another antenna, the receptions may be combined, optionally with larger weight to the latter antenna. Optionally, the weights have different signs so that a weighted difference in reception is obtained, for example, for noise or distortion reduction. Optionally, phase correction is applied (and optionally configured for).

In exemplary embodiments of the invention, a plurality of antennas may be used, optionally simultaneously, for receiving a corresponding plurality of transmissions, e.g., using different frequencies, such that the communication throughput is enlarged.

### Exemplary Base Station Systems

FIG. 2 schematically illustrates a wireless system having a base station 200 comprising a transceiver (transmitter/receiver) 202 communicating with a wireless terminal 100 of FIG. 1, in accordance with exemplary embodiments of the invention. Terminal 100 optionally represents a plurality of terminals 100 in a point-to-multi-point system,

In exemplary embodiments of the invention, transceiver 202 is mounted on a fixture 204, such as a tower. Fixture 204 may comprise, for example, a tower or high building. Fixture 204 may be useful, for example, for supporting communications with a plurality of terminals 100 that may be dispersed in the area about transceiver 202. Optionally, there is a line of sight between transceiver 202 and wireless terminal 100 (e.g., antennas thereof).

In some case or embodiments of the invention, base station 200 represent a plurality of base stations 200.

In some case or embodiments of the invention the wireless system comprises at least one terminal and at least one base station. Optionally, the wireless system comprises a plurality of terminals and/or a plurality of base stations.

For some embodiments of the invention, base station 200 represents any device that relays and/or manages and/or coordinates communications with other devices, such as, for example, terminal 100.

### Outline of Configuration in Absence Mode

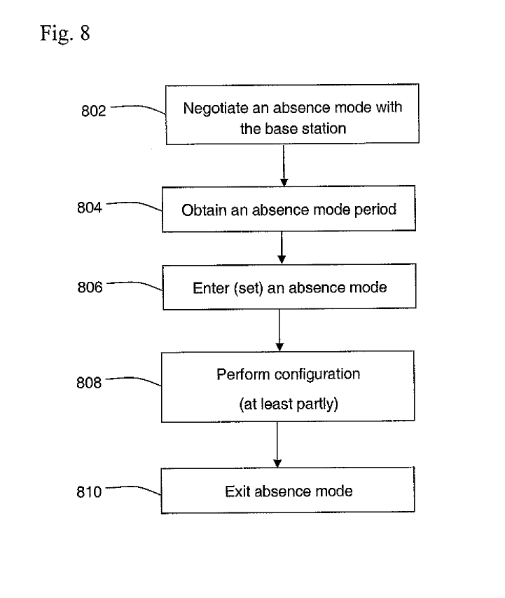

FIG. 8 is a flowchart schematically outlining a simplified operation sequence for configuring a wireless terminal using an absence mode, in accordance with exemplary embodiments of the invention.

A terminal, such as terminal 100 of FIG. 1 negotiates with the base station such as base station 200 of FIG. 2 to obtain an absence mode period (802). According to the negotiations the terminal obtains an absence mode period (804) and the terminal enters or sets into an absence mode states (806).

Once the terminal sets an absence mode the terminal performs a configuration, optionally only partly, as the period allows (808). Optionally, the configuration is re-planned to fit into the allotted period and/or divided up to fit into the allotted plurality of periods.

Once the configuration, or a desired part thereof is done, the terminal exits the absence mode state.

In some cases, additional absence mode periods may be requested in order to complete the configuration.

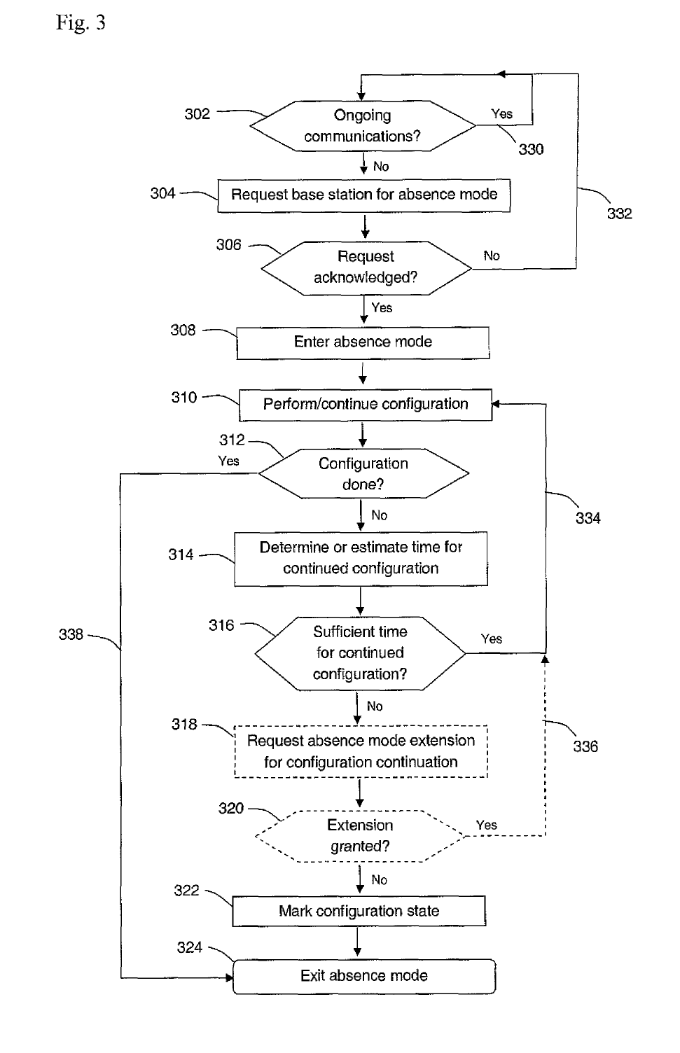

FIG. 3 is a flowchart schematically outlining an operation sequence for configuring a wireless terminal such as terminal 100 of FIG. 1 in an absence mode obtained from a base station such as base station 200 of FIG. 2, in accordance with exemplary embodiments of the invention.

In some embodiments the terminal checks if it is feasible to enter or set an absence mode, namely, if there is an ongoing communication with the base station (302). If the communication is ongoing, the terminal periodically re-checks if the communications is alive (330). If the communication is paused or stopped (optionally for a determined or preset lapse of time) the terminal requests from the base station an absence mode duration. Optionally, the requested duration is according to the configuration operations or activities the terminal is about to perform or has partially performed in a previous absence mode period (304), optionally, within the parameters allowed by system protocol (e.g. sleep mode or handoff mode). In an exemplary embodiment of the invention, there is provided a hierarchy of absence mode types, optionally ordered according to preference. Optionally, once permission is not provided for one mode (or a threshold or requested time is passed), a next type is asked for.

The base station may deny the request, for example, due to memory congestion or other activities such as an incoming message that arrives, or expected to arrive, for the terminal. Optionally or alternatively, the base station may allow a shorter time period. Accordingly, the terminal resumes checking for ongoing communications (332).

If the base station acknowledges the request (306), the base station allocates to the terminal an absence period according to the requested absence mode and/or the system protocol. It should be noted that the allocated period may not suffice for the configuration (see more below). When the absence mode request is acknowledged (granted) by the base station the terminal enters or sets an absence mode (308). If the duration is not sufficient, the absence mode may be rejected and a new request sent at a same or later time.

Optionally or alternatively, the base station notifies the terminal that the terminal may enter an absence mode, for example, if no messages are pending for the terminal. In such as a case the terminal enters or sets an absence mode for a time optionally allocated by the base station or a programmed or preset period. Optionally, the terminal enters absence mode after acknowledging the base station.

When in absence mode the terminal optionally keeps track of the time for expiration or determines the time left, typically in units of packets or frames (typically, without limiting, each is a few milliseconds long). Once the terminal is in absence mode the terminal begins (or resumes, see more below) the configuration (310), preferably, but not limited to, up to a well defined state of the configuration, e.g. one antenna was switched, or up to a recoverable state of the configuration.

In an exemplary embodiment of the invention, configuration comprises continuously and/or repeatedly scanning the antennas and switching to the strongest antenna each time. Optionally, each such scanning is split into steps (e.g., each step being measuring one or more antenna) with different steps being done in different absence periods. Optionally, the scanning is carried out periodically. Optionally, the periodicy is increased if the communication is determined to be of a degraded quality. Optionally or alternatively, the order of scanning is changed, for example, randomly.

The terminal determines whether the configuration is finished within the allocated period (312). If the configuration completed (338) the terminal exits the absence mode (324), optionally, without limiting, waiting for the expiration of the absence mode period.

If the configuration is not done yet (e.g., within the absence mode period), the terminal determines or estimates the time for continuing the configuration (314), such as switching to another antenna or determining a new base station (see below). If the terminal determines or estimates that the time for continuing the configuration is sufficient (316), the configuration proceeds (334 to 312). If the determined or estimated time is not sufficient for continuing the configuration, the terminal optionally requests the base station for absence mode extension for configuration continuation (320). If the extension is granted (acknowledged) the configuration proceeds (336 to 312).

If the extension is not granted by the base station, the terminal suspends the configuration and saves (marks) the state of the configuration (322) for optional later continuation, and the terminal exits the absence mode (324), optionally when the absence mode period expires.

In some embodiments of the invention, the absence mode period may not be sufficient for carrying out a well-defined part of the configuration or for reaching a well-defined state of the configuration (i.e. the absence mode time would expire). For such a case, optionally, the configuration processes establishes a roll-back well-defined state from which the configuration can restart or resume later on (see below). Optionally or alternatively, before starting or continuing the configuration (310) the terminal can determine or estimate if the absence mode period is sufficient for definite or well-defined configuration state (similar to operation 314). If the time is not sufficient, optionally the terminal determines to request the base station for absence mode time extension (318) or optionally to exit the absence mode (324) and re-try again (see more below).

In some embodiments of the invention, if the configuration did not finish in an earlier absence mode, the terminal, optionally after a determined or planned delay, request the base station for absence mode period as before (302-306). If absence mode is granted, the terminal resumes the configuration (310), optionally from the state the configuration was suspended (in 322), as described above. In an exemplary embodiment of the invention, the delay time is determined (e.g., using a table or an analytical function) as a function of the activity of the terminal. Optionally or alternatively, the terminal keeps track of the typical time to receive an approval of absence and based its time of request and/or request duration based on the typical delay time.

In some embodiments, for example, if the configuration did not finish during the second absence mode, the sequence in 302 to 324 as describe above is repeated until the configuration is done or abandoned.

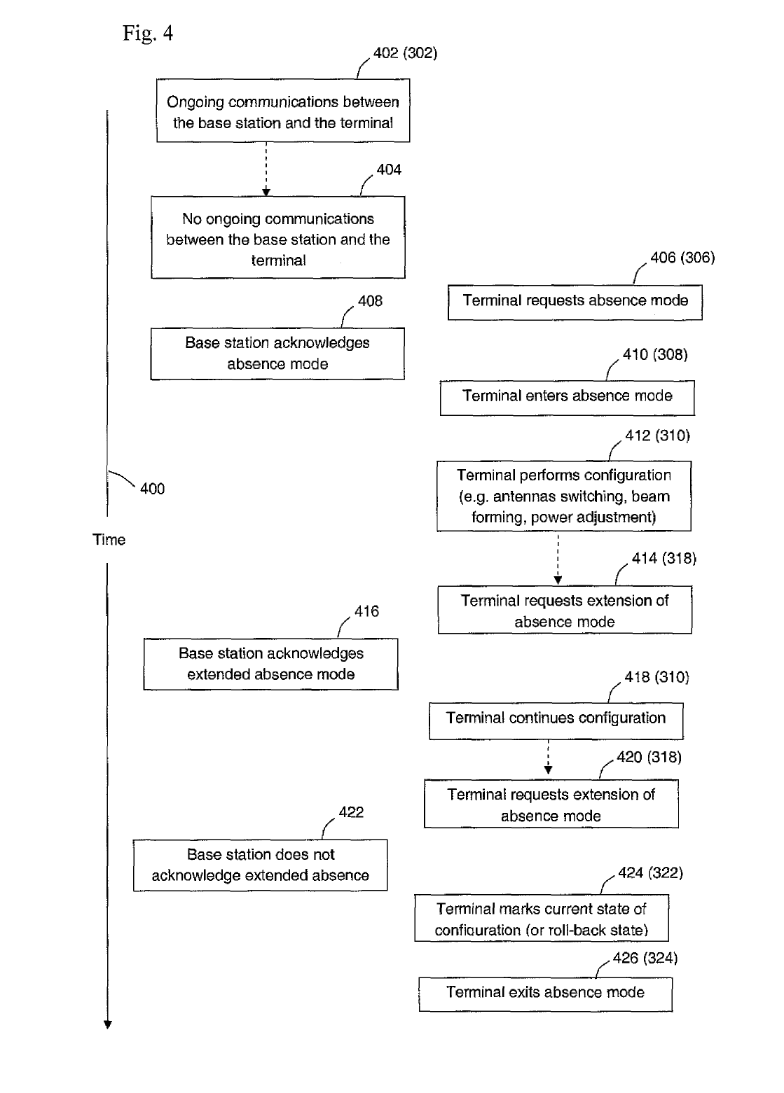

FIG. 4 is a time-line schematically outlining an operation sequence for configuring a wireless terminal in an absence mode, in accordance with exemplary embodiments of the invention.

In the following description that exemplifies, without limiting, a scenario of configuration in an absence mode, reference is made to FIG. 3 and the description thereof above (FIG. 3 operations in parentheses) where time progress 400 is shown without scaling.

The terminal communicates with the base station (402) until there is no communications for at least a determined or planned or known time (404). In an exemplary embodiment of the invention, absence is requested (e.g., and used for antenna switching), even if there is traffic. Optionally, the absence time duration is kept below a percentage of the time being used, for example, to be less than 10%, 5%, 1% or 0.5% of the time used for communication, so as to have a minimal effect of the data link. Optionally or alternatively, the rate of absence requests is modified to have a reduced effect on the data link. For example, the rate, length and/or other properties of the requests may depend on the type of data being sent (e.g., images are less sensitive to interruption than audio, so more absence requests may be had). The terminal requests from base station an absence mode period (406), typically without limiting, according to the system protocol and optionally, according to the configuration the terminal determines or planned to perform. The base station acknowledges (grants) the request (408) and the terminal enters or sets an absence mode (410).

The terminal performs, at least partially, a configuration such as antenna switching, beam forming, power adjustment and/or other configurations or operations (412). However, the terminal determines or estimates that the terminal cannot finish the configuration in the granted absence mode period and requests from the base station an extension of the absence mode period (414) and/or request a new period of absence, optionally contiguous or overlapping with the ongoing period. The base station acknowledges the request (416) and the terminal proceeds with the configuration. Still, even the extended period is determined or estimated to be too short for completion of the configuration and the terminal requests another absence mode period extension (420) but the base station does not acknowledge the request (422), due, for example, for pending messages for the terminal.

The terminal marks the current configuration state (or a well-defined roll-back state) from which the terminal may proceed the configuration (424) and the terminal exits the absence mode (426).

### Antenna Switching

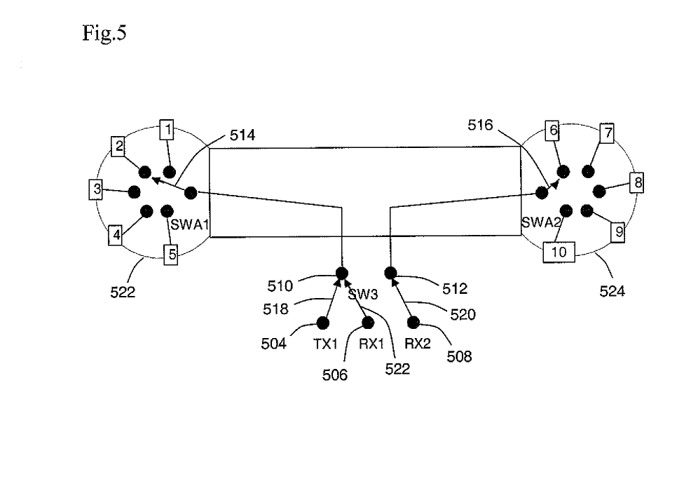

FIG. 5 schematically illustrates an arrangement for antenna switching in a terminal comprising a plurality of antennas such as terminal 100 of FIG. 1, in accordance with exemplary embodiments of the invention.

According to the example shown in FIG. 5, the terminal comprises two arrays of antennas, each comprising 5 antennas, and in each array an antenna is selectable for use in communications.

In some embodiments of the invention an electrical (or electronic) contact 504 connects to a transmission channel circuitry of a terminal, and electrical (or electronic) contacts 506 and 508 connect to two reception channels circuitry of a terminal, respectively. Contact 504 can connect to an antenna in either of antennas array 522 or 524 via (a) a switch 518 and (b) a switch 514 or 516 in antennas array 522 or 524, respectively. Similarly, contact 506 can connect to an antenna in either of antennas array 522 or 524 via (a) a switch 522 and (b) a switch 514 or 516 in antennas array 522 or 524, respectively. Similarly, contact 508 can connect to an antenna in either of antennas array 522 or 524 via (a) a switch 520 and (b) a switch 514 or 516 in antennas array 522 or 524, respectively. It should be noted that transmission contact 504 connection to contacts 510 or 512 and reception contacts 506 and 508 to contacts 510 or 512 are, optionally, mutually exclusive; that is, the terminal is either in a transmission or reception, but not concurrently.

In some embodiments of the invention, the antenna switching is carried out during an absence mode, in accordance with the sequence described above with respect to FIG. 3.

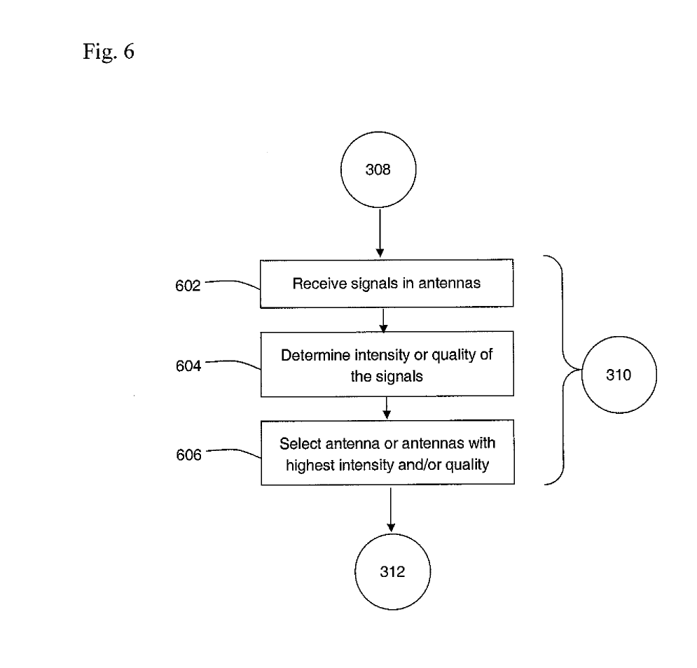

Referring to FIG. 3 in general and operation 310 (perform/continue configuration) in particular, in some embodiments of the invention the configuration comprises antenna switching. FIG. 6 is a flowchart schematically illustrating operations in antenna switching in a wireless terminal such as terminal 100 comprising a plurality of antennas such as antennas 104 of FIG. 1, in accordance with exemplary embodiments of the invention.

In some embodiments of the invention the absence mode period requested by the terminal is according to the system protocol, such as being a sleep mode or a handoff mode. Optionally, the terminal requests an absence mode period according to the time the terminal determines or estimates is needed for the antenna switching.

When the terminal enters absence mode (310) the terminal optionally determines or estimates if the absence mode period is sufficient for selection of at least one antenna. If time is not sufficient the process proceeds to operation 318 or 322.

In some embodiments of the invention, when the terminal enters absence mode the terminal marks (e.g., saves) the current active antenna or antennas so that if a switching is not finished in the current absence mode, the operation of the terminal can resume the state before the absence mode.

In some embodiments, once the terminal is ready for antenna switching, the terminal listens (e.g., receiving wireless signals) using one or more antennas, to communications from a base station such as base station 200 (602). Optionally, the signals comprise a maintenance broadcast by the base station (or other base stations). Optionally or alternatively, the signals comprise signals (optionally comprising messages) intended for one or more other terminals or devices of the wireless system and optionally not the terminal. In an exemplary embodiment of the invention, the antenna selected for probing is selected using a round-robin scheme.

In some embodiments of the invention, the received signals are analyzed, optionally over a determined and/or planned and/or programmed period of time, and the terminal determines one or more characteristics of the signal, such as the intensity and/or quality of the communications (604).

In some embodiments of the invention, the signal intensity is expressed by one or more indications. Optionally, an indication comprises a received-signal-strength-indication (RSSI). Optionally, an RSSI is a value dependent on the circuitry of the terminal. Typically, without limiting, an RSSI value is in a range between 0 and 255 or less, and may be represented as a percentage of the range. Optionally, the indication is in energy units, such as mW or dBm. Optionally, the intensity indication comprises a carrier-to-interference ratio (CIR) or a signal to noise ratio (SNR), or a combination of one or more signal intensity indications.

In some embodiments of the invention, the quality of a signal is determined by an error level. For example, the error level comprises an error rate, or the number of errors within a packet or a frame, or the number of errors within a time period, or a combination thereof.

In an exemplary embodiment of the invention, the type of error monitored and/or weight given to different types of errors, and thereby antenna selection, depends on the application. For example, some applications will prefer a lower packet loss and in others lower error rate and/or higher bandwidth. Optionally, the monitoring is based on a current or future expected activity of the terminal. Optionally or alternatively, the terminal keeps track of the relative suitability of various antennas and switches even without scanning all the antennas, for example, based on planned use. Optionally, a short scan to ensure the switched to antenna is of a minimal or better quality, is provided. Similarly, other communication parameters may be selected and/or tested for according to the task carried out by the terminal.

Responsive to the signal intensity and/or quality, the terminal selects an active antenna or antennas (606), optionally for subsequent normal communications in transmission and/or reception (reference is made to FIG. 5 for an example of antennas selecting). Optionally, the selection is based on the relative signals intensity indications of the antennas, so that an antenna or antennas that received the highest intensities are selected. Optionally or alternatively, antennas with the best signal quality are selected. Optionally or alternatively, the selection is based on a combination of signals intensity and/or quality.

In exemplary embodiments of the invention, one antenna is selected as an active antenna for a normal communications that may follow. Optionally, a plurality of antennas is selected as active antennas, for example, two antennas. Optionally, the remaining antennas (unselected antennas) are inactive, or are set in high impedance, or set in other states other than for normal communications.

In some embodiments of the invention, the timing for selecting an antenna as an active antenna such as a transmitting antenna is based on a timing of a communication frame or packet. For example, when the terminal communicates with the base station and a communication frame time or transmission window time is due or started, an antenna is selected as an active antenna. Optionally, an active antenna alternates among the selected antennas on a frame or packet basis. In embodiments of the invention, selecting an active antenna is according to the system protocol, such as determining the timing for the selection of the antenna. In an exemplary embodiment of the invention, the switching is selected according to a timing which will minimally disrupt an ongoing communication.

In some embodiments of the invention, one or more of the selected antennas comprise a transmitting antenna or antennas or a receiving antenna or antennas. Optionally, an active antenna is used for both transmission and reception, for example, alternating in time between the two roles e.g. based on the timing protocol of the wireless system.

In some embodiments once an antenna or antennas are selected, that is, a configuration is done (at least for one pass for antenna selection) the process proceeds to operation 312 of FIG. 3 (configuration done?). In case the absence mode period is about to expire without an antenna selection, in some embodiments the terminal reverts to the saved state, namely, to the antennas in use before the absence mode started. Optionally or alternatively, the best antenna detected until the absence period is over, is selected.

In some embodiments of the invention antenna switching and/or selection is continued in subsequent absence modes similarly as described above.

In some embodiments of the invention antenna switching is carried out in a plurality of passes if the absence mode time allows. Optionally, a subset of the plurality of antennas is switched in one pass and another subset of the plurality of antennas is switched in another and/or other passes. In some embodiments the subsets are determined based on past and/or present reception and transmission intensities and/or qualities, or based on variations in receptions in a plurality of antennas, and/or due to absence mode time constraints.

In some embodiments of the invention, the antennas switching has no detrimental effect, or only negligible or insignificant effect, on the terminal energy resources. For example, listening and receiving signals (602) may be performed substantially instantaneously (e.g., within a short period), and the determination of the received signals (604) and switching of antennas (606) may consume a negligible amount of energy, for example, relative to normal operation of the terminal. For example, the energy level of the system, or of a transmitter part thereof may be less than 10% that of during normal transmission operation and/or as described above with regard to energy reduction. Optionally, the listening and receiving comprises a part of other activities in the absence mode such as periodic listening. Possibly, the extra power used for antenna switching does not perceptibly affect the normal communications operation of the terminal. The terms ‘negligible’ or ‘insignificant’ as used in the specifications and claims, unless otherwise specified, denote an effect or occurrence that does not perceptively affect the operation of the involved devices.

In some embodiments of the invention the absence mode is used, optionally as a part of antenna switching, to adjust the power of the terminal. Optionally, the power is adjusted such as to have or attain a sufficient quality of communications (e.g. in terms of error rate) while avoiding expenditure of superfluous power which is not required.

For example, when a switched antenna provides a stronger communication signal than before, the terminal may reduce transmission and/or reception power, thereby saving energy resources. In an exemplary embodiment of the invention, this reduction is based on an assumption of reciprocity of the channel in a TDD system—that there is direct link between the signal level received and the transmit level. For example, if switching the antenna increased the RSSI level by 5 dB, it may be assumed that, for a same data rate, the transmit level can be reduced by 5 dB.

In some embodiments of the invention the absence mode is used, optionally as a part of antenna switching, to utilize the selected antennas for forming a beam for a better, or best, communications with the base station. Optionally, the antennas are selected and/or set up for beam forming optionally using methods known in the art, however, this is carried out and/or tested during an absence period.

In exemplary embodiments of the invention, the antenna switching does not require a modification in another device participating in the communication, such as the base station or the base station transmitter.

In an exemplary embodiment of the invention, the switching and/or checking for antenna to switch to are carried out at least once a minute, once in 10 seconds, once a second, between 2 and 10 times a second and/or more often, for example, at least 60 times a second. In an exemplary embodiment of the invention, the absence mode is requested and/or antenna configuration checked, at Least once in two seconds, once a second or three times a second. These rates are optionally maintained for at least 50%, 70%, 80% or 90% of a time of operating of the system.

### Handoff

In some cases or embodiments of the invention, an absence mode comprises a handoff period. Optionally, the action taken during an absence mode (not necessarily a handoff mode) comprises a handoff.

In some cases or embodiments of the invention, in a handoff operation, the terminal (such terminal 100 of FIG. 1) determines a base station (such as 200 of FIG. 2) for communications, optionally reverting to another base station instead of the current base station.

In some embodiments of the invention the handoff is carried out in an absence mode, optionally in accordance with the sequence described above with respect to FIG. 3.

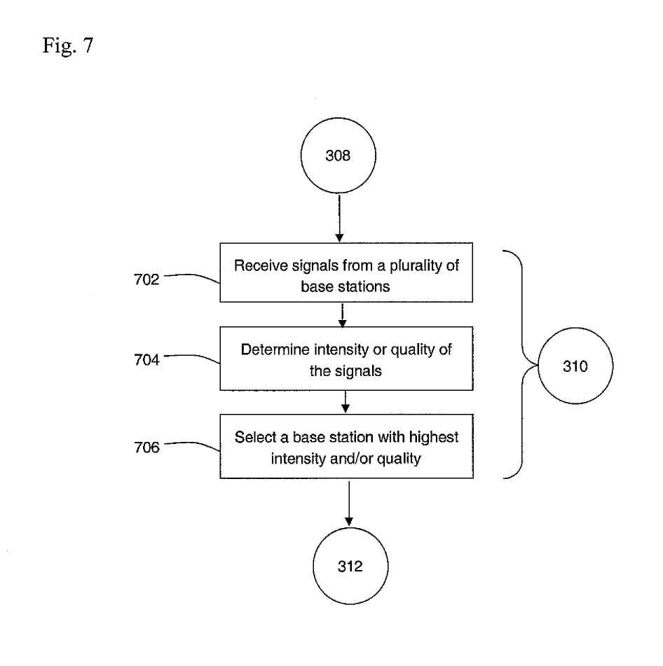

Referring to FIG. 3 in general and operation 310 (perform/continue configuration) in particular, in some embodiments of the invention the configuration comprises a handoff operation. FIG. 7 is a flowchart schematically illustrating operations in a handoff operation in a wireless terminal (such terminal 100 of FIG. 1), in accordance with exemplary embodiments of the invention.

In some embodiments of the invention the absence mode period requested by the terminal is according to the system protocol, such as sleep mode or handoff mode. Optionally, the terminal request absence mode period according to the time the terminal determines or estimates is needed for the antenna switching.

When the terminal enters absence mode (310) the terminal optionally determines or estimates if the absence mode period is sufficient for a handoff operation, at least for determining the quality of communication with one base station. If time is not sufficient the process proceeds to operation 318 or 322.

In some embodiments of the invention, when the terminal enters absence mode, the terminal marks (e.g., saves) the current base station so that if a switching is not finished in the current absence mode, the operation of the terminal can resume the state before the absence mode (e.g. the original base station).

In some embodiments, once the terminal is ready for a handoff operation, the terminal listens (receiving wireless signals) from a plurality of base stations such as base station 200 (702) (scanning). Optionally, the signals comprise a maintenance broadcast by the base station. Optionally or alternatively, the signals comprise signals (optionally comprising messages) intended to one or more other terminals or devices of the wireless system.

In some embodiments of the invention, the received signals are analyzed, optionally over a determined and/or planned and/or programmed period of time, and the terminal determines the intensity and/or quality of the communications (704) as described above, at least partly, for the antenna switching operation.

In an exemplary embodiment of the invention, responsive to the signal intensity and/or quality from each base station, the terminal selects the base station for subsequent communication. Optionally, without limiting, the terminal selects the base station with which it communicates with the highest intensity and/or quality (706) and subsequently the terminal switched from the current base station to the selected base station (handover).

In some embodiments of the invention the terminal comprises a plurality of antennas, and the handoff operation comprises antennas selection as described above. For example, the base station is selected according to an antenna that communicates with a base station with the highest intensity and/or quality rather than using the current active antenna or antennas. Optionally or alternatively, the handoff absence mode period is used for antenna switching only, as described above.

### Exemplary Protocols

In exemplary embodiments of the invention, wireless terminal 100 communicates according to a standard wireless protocol. Optionally, the protocol conforms to standards such as an OFDM (Orthogonal Frequency Division Multiplexing) protocol, or a cellular protocol, or a WiMax protocol, or a WiFi protocol, or a BlueTooth protocol, or a ZigBee protocol. Additional exemplary protocols include CDMA, GSM, LTE, UMTS and OFDMA. Optionally, other protocols that support an energy-saving mode or other type of absence mode where a party can be not be involved in standard data exchange with the system, are used. Optionally, the protocols are non-standard or proprietary and include the ability for a base station to suggest and/or approve an absence mode and/or the ability for a terminal to enter such a mode.

In an exemplary embodiment of the invention, an absence mode is a mode where the terminal is not a normal working component of the system. For example, the terminal may not transmit or receive data streams as before the absence mode. Such an absence may be complete (e.g., no system connection) or partial (e.g., reduced bandwidth and/or reduced number of channels and/or antenna active). In an exemplary embodiment of the invention, the absence mode comprises a low energy mode, where less energy is supposed to be used by the terminal. Optionally, the amount of energy used is reduced, but not as such as expected from such a mode, due to the configuration activities. For example, the terminal may use 200% 300%, 400% or more of the expected energy usage.

In another example, the absence mode is a non-transmission mode or a non-listening mode where the terminal is not supposed to transmit or receive, respectively. In another example, the terminal is in a scanning mode, where it is looking for channels and/or base-stations, possibly from another network. In another example, the terminal is in a non-linked mode where it is disconnected from the base-station, for example, for connection to another base station.

In an exemplary embodiment of the invention, the software in the terminals and/or base station is configured to indicate a purpose for taking the absence mode. For example, in the terminal, there may be a timer indicating when antenna switching should be checked for, which timer causes an absence mode to be requested and then used.

In an exemplary embodiment of the invention, the basic protocol of the base station is not changed and any use of the absence mode for configuration is carried out without the specific cooperation of the base station. Alternatively, the base station may be programmed to take into account such usage. In one embodiment, the protocol is changed so that a terminal can state why the absence mode is requested. Optionally or alternatively, the protocol si not changed, but the base station is aware of such usage of absence modes and when it detects a series of requests treats them as such or includes a flag for terminals that use an absence mode for configuration. Such a flag may be useful in approving absence modes when needed and/or allowing the base station to tradeoff system considerations and terminal considerations.

Potential Motivations and/or Benefits

In some embodiments of the invention, the antenna switching and/or handoff is beneficial as a terminal in the form of a wireless device may be in motion and the intensity or quality of reception and/or transmission varies and/or deteriorates from a previous or initial position. Optionally and additionally, antenna switching and/or handoff may improve communications that may vary due to atmospheric or environmental effects, such as buildings or power lines. Optionally or additionally, when a switched antenna or base station provides better communication than before, the device may lower the power for transmission and/or receiving, preserving battery capacity and reducing radiation interferences in the environment.

### General

All trademarks are the property of their respective owners.

In the specifications and claims, unless otherwise specified, the terms ‘software’, ‘program’, ‘procedure’ or ‘module’ or ‘code’ may be used interchangeably and denote one or more instructions, comprises in a storage medium, and executable by a computing apparatus (such as computer, processor, a DSP or a dedicated apparatus).

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As used herein, the terms “comprises”, “comprising”, “includes”, “including”, “having” and their conjugates mean “including but not limited to”. The term “consisting of means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a procedure” or “at least one procedure” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

The present invention has been described using detailed descriptions of embodiments thereof that are provided by way of example and are not intended to necessarily limit the scope of the invention. The described embodiments comprise different features, not all of which are required in all embodiments of the invention. Some embodiments of the invention utilize only some of the features or possible combinations of the features. Alternatively and additionally, portions of the invention described/depicted as a single unit may reside in two or more separate physical entities which act in concert to perform the described/depicted function. Alternatively and additionally, portions of the invention described/depicted as two or more separate physical entities may be integrated into a single physical entity to perform the described/depicted function. Variations of embodiments of the present invention that are described and embodiments of the present invention comprising different combinations of features noted in the described embodiments can be combined in all possible combinations including, but not limited to, use of features described in the context of one embodiment in the context of any other embodiment.

1. A method for configuring a terminal in a wireless system comprising at least one terminal and at least one base station, comprising:
(a) negotiating between a terminal with a base station to obtain an absence period for the terminal,
(b) setting the terminal in an absence mode with respect to the base station; and
(c) at least partially configuring the terminal independently of the base station, during the absence mode.

2. A method according to claim 1, wherein the configuration is carried out without notifying the base station.

3. A method according to claim 1, wherein the configuration is carried out without coordinating the configuration with the base station.

4. A method according to claim 1, wherein the configuration is carried out independently of the system protocol.

5. A method according to claim 1, wherein the configuration does not require a modification in another device communicating with the terminal.

6. A method according to claim 1, wherein the configuration comprises switching antennas in a terminal comprising a plurality of antennas.

7. A method according to claim 6, wherein switching antennas comprises:
(a) receiving signals in a plurality of antennas; and
(b) selecting at least one antenna as an active antenna.

8. A method according to claim 7, wherein selecting is according to at least one characteristic of the signals.

9. A method according to claim 8, wherein a characteristic of a signal comprises at least one of an indication of the intensity of a signal, or a quality of a signal, or a combination thereof.

10. A method according to claim 9, wherein an indication of the intensity of a signal comprises at least one of a received-signal-strength-indication (RSSI), or carrier-to-interference-ratio (CIR), or signal-to-noise ratio (SNR), or a combination thereof.

11. A method according to claim 9, wherein an indication of the quality of a signal comprises at least one of an error rate, or percentage of errors, or a combination thereof.

12. A method according to claim 7, wherein the antennas switching consumes a negligible amount of energy for transmission relative to energy consumption for transmission in normal operation of the terminal.

13. A method according to claim 7, wherein the antennas switching consumes less than 50% of the energy level used for normal operation of the terminal.

14. A method according to claim 1, wherein the configuration comprises adjusting the power of the terminal.

15. A method according to claim 14, wherein adjusting the power comprises setting the power to attain a sufficient quality of communications while avoiding expenditure of superfluous power.

16. A method according to claim 1, wherein the configuration comprises forming a beam of one or more antenna at the terminal.

17. A method according to claim 16, wherein a beam is formed by a plurality of antennas in a terminal comprising a plurality of antennas.

18. A method according to claim 1, wherein the configuration comprises a handoff operation.

19. A method according to claim 1, wherein the wireless system conforms to a standard wireless protocol.

20. A method according to claim 19, wherein the protocol comprises an OFDM (Orthogonal Frequency Division Multiplexing) protocol.

21. A method according to claim 19, wherein the protocol comprises a wireless protocol.

22. A method according to claim 21, wherein the protocol includes a provision for a low energy state of the terminal.

23. A method according to claim 22, wherein the protocol is one of a WiMax protocol, or a cellular protocol, or a WiFi protocol, or a BlueTooth protocol, or a ZigBee protocol.

24. A method according to claim 1, wherein the terminal comprises a mobile device.

25. A method according to claim 1, wherein the absence mode comprises a less than fully active mode, including one or more of a low energy mode, a sleep mode, idle mode, handoff mode, non-transmission mode, non-listening mode, scanning mode or non-linked mode.

26. A method for deceptively obtaining from a base station an absence mode period for a terminal in a wireless system comprising at least one terminal and at least one base station, comprising:
(a) negotiating with the base station to obtain an absence mode period for the terminal according to an intended configuration process by the terminal; and
(b) obtaining, from the base station, and using an absence mode period for a purpose unrelated to the absence mode as negotiated with the base station.

27. A method according to claim 26, wherein negotiating comprises requesting by the terminal an absence mode period from the base station.

28. A method according to claim 26, wherein the purpose is at least a part of the intended configuration.

29. A method according to claim 26, wherein the absence mode period is obtained in plurality of consecutive absence mode periods.

30. A method according to claim 29, wherein a terminal configuration is carried out partially in the consecutive absence mode periods.

31. A method according to claim 26, wherein an intended configuration is responsive to an unfavorable situation of the terminal.

32. A method according to claim 31, wherein an unfavorable situation comprises at least one of a deteriorating reception power or deteriorating reception quality.

33. A method according to claim 26, wherein an intended configuration is responsive to at least one of a scheduled event, or low power situation, or power loss event, or a manual event.

34. A method according to claim 33, wherein a manual event comprises an operation by a person.

35. A method according to claim 26, wherein the purpose comprises switching antennas in a terminal comprising a plurality of antennas.

36. A method according to claim 26, wherein the purpose comprises forming a beam.

37. A method according to claim 26, wherein the purpose comprises a handoff operation.

38. A method according to claim 26, wherein the absence mode comprises a less than fully active mode, including one or more of a low energy mode, a sleep mode, idle mode, handoff mode, non-transmission mode, non-listening mode, scanning mode or non-linked mode.

39. A wireless device configured for configuration, comprising:
(a) circuitry which performs at least one of negotiating, requesting, accepting and applying for an absence mode; and
(b) at least one module which configures the device while in an absence mode.

40. A device according to claim 39, wherein the at least one module comprises at least one of a hardware or software module.

41. A device according to claim 39, wherein configuration comprises antenna switching in a device comprising a plurality of antennas.

42. A device according to claim 39, wherein the configuration comprises forming a beam.

43. A device according to claim 39, wherein the absence mode comprises a less than fully active mode, including one or more of a low energy mode, a sleep mode, idle mode, handoff mode, non-transmission mode, non-listening mode, scanning mode or non-linked mode.

44. A device according to claim 39, wherein the device is portable.

45. A WiMax system comprising a WiMax base station and a plurality of devices according to claim 39, which serve as terminals, wherein said base station is programmed to accept absence mode requests independently of their usage by said terminals.
